(19) United States
(12) Patent Application Publication
(10) Pub. No.: US 2018/0085626 A1
(43) Pub. Date: Mar. 29, 2018

(54) METHOD AND SYSTEM FOR CALCULATING WORK DONE BY PEDALING AND SMART PEDAL

(71) Applicant: National Tsing Hua University, Hsinchu City (TW)

(72) Inventors: Jang-Ping Sheu, Hsinchu City (TW); Yung-Ching Kuo, Taichung City (TW)

(73) Assignee: National Tsing Hua University, Hsinchu City (TW)

(21) Appl. No.: 15/368,259

(22) Filed: Dec. 2, 2016

(30) Foreign Application Priority Data
Sep. 23, 2016 (TW) 105130707

(51) Int. Cl. A63B 24/00; B62J 99/00; G01L 5/22; G01L 3/04; A63B 71/06

(52) U.S. Cl. CPC A63B 24/0062; B62J 99/00; G01L 5/225; G01L 3/04; A63B 2220/62; B62J 2099/002; B62J 2099/0013; A63B 2220/56; A63B 2220/20; A63B 71/0619

(57) ABSTRACT

A method and a system for calculating a work done by pedaling and a smart pedal are provided. The method is adapted for a calculation apparatus to calculate a work done by a user pedaling a bicycle apparatus including a smart pedal disposed at an end of a crank arm opposite to a chainring and an orientation sensor for detecting a rotation angle of the crank arm. In the method, a pedaling force applied by the user to the smart pedal is detected by using a pressure sensor; meanwhile, the rotation angle of the crank arm when the user pedals the smart pedal is detected by using the orientation sensor. The work done by the user on the smart pedal is calculated based on the pedaling force and the rotation angle of the crank arm detected at each time point within a time period that the user applies the force.

### CROSS-REFERENCE TO RELATED APPLICATION

This application claims the priority benefit of Taiwan application serial no. 105130707, filed on Sep. 23, 2016. The entirety of the above-mentioned patent application is hereby incorporated by reference herein and made a part of this specification.

### BACKGROUND OF THE INVENTION

### Field of the Invention

The present disclosure relates to a method and an apparatus for calculating a work, and in particular, a method and a system for calculating a work done by pedaling and a smart pedal.

### Description of Related Art

As people today are more and more enthusiastic about exercising, jogging, swimming, and cycling are all quite popular sports. When cycling, a user may want to know how many calories are consumed during the cycling process. The products currently on the market use torque sensors to measure the work, wherein angles are integrated by using torque values between the large chainring and the crank arm of the bicycle to obtain data of the work done by the crank arm on the large chaining, and calories consumed by the user can thereby be converted.

FIG. 1A to FIG. 1C are diagrams illustrating relationships between an applied force and a rotation angle of a crank aim in a conventional bicycle pedaled by a user. The direction of the pedal of the bicycle pedaled by the user changes over time. Only in the state where a pedal 12 is parallel to a crank arm 14 will a force F applied by the user to the crank arm 14 be equal to a force applied by the crank arm 14 to the large chainring 16 (as illustrated in FIG. 1A). In the other states, calculation of the force F applied by the user to the crank arm 14 should always consider component forces in a direction perpendicular to the crank arm 14 (as illustrated by a component force F₁ in FIG. 1B and a component force F₂ in FIG. 1C), and component forces in a direction parallel to the crank arm 14 are lost as negative work. It follows that products as described above can only calculate the work obtained by the bicycle, but this value is smaller than the work actually done by the user, which causes the converted calories to be inaccurate.

### SUMMARY OF THE INVENTION

The invention provides a method and a system for calculating a work done by pedaling and a smart pedal that accurately calculate a work done by a user pedaling a bicycle pedal.

The method for calculating a work done by pedaling of the invention is adapted for a calculation apparatus to calculate a work done by a user pedaling a bicycle apparatus, wherein the bicycle apparatus includes a smart pedal disposed at an end of a crank arm opposite to a chainring and an orientation sensor for detecting a rotation angle of the crank arm. In the method, a pedaling force applied by the user to the smart pedal is detected by using a pressure sensor on the smart pedal. The rotation angle of the crank arm at the time the user pedals the smart pedal is detected by using the orientation sensor. The work done by the user on the smart pedal is calculated based on the pedaling force and the rotation angle of the crank arm detected at each time point within a time period that the user applies force.

In one embodiment of the invention, the step of calculating the work done by the user on the smart pedal based on the pedaling force and the rotation angle of the crank arm detected at each time point within the time period that the user applies force includes calculating a vertical displacement of the smart pedal within the time period based on a length of the crank arm and the rotation angle and multiplying the detected pedaling force by the vertical displacement to calculate the work.

In one embodiment of the invention, the step of multiplying the detected pedaling force by the vertical displacement to calculate the work includes calculating a statistic value of the pedaling force detected within the time period and multiplying the statistic value by the vertical displacement as the work, wherein the statistic value includes a mean value and a maximum value.

In one embodiment of the invention, the method further includes detecting an inclined angle of the smart pedal at each time point by using an inclination sensor on the smart pedal, calculating a displacement of the smart pedal in a direction of the pedaling force by using the detected inclined angle and rotation angle, and calculating the work done by the user on the smart pedal based on the pedaling force detected at each time point and the calculated displacement.

In one embodiment of the invention, the method further includes detecting a work done by the crank arm on the chaining of the bicycle apparatus by using a torque sensor within a time period that the pressure sensor detects the pedaling force, and calculating a difference between the work calculated based on the pedaling force and the rotation angle of the crank arm and the work detected by the torque sensor to generate an energy loss of the user pedaling the smart pedal.

The system for calculating a work done by pedaling of the invention includes a smart pedal, an orientation sensor, and a calculation apparatus. The smart pedal is disposed at an end of a crank arm of a bicycle apparatus opposite to a chainring and includes a pressure sensor for detecting a pedaling force applied by a user to the smart pedal. The orientation sensor is disposed at the crank arm for detecting a rotation angle of the crank arm at the time the user pedals the smart pedal. The calculation apparatus connects the smart pedal and the orientation sensor for calculating a work done by the user on the smart pedal based on the pedaling force and the rotation angle of the crank arm detected at each time point within a time period that the user applies force.

In one embodiment of the invention, the calculation apparatus includes calculating a vertical displacement of the smart pedal within the time period based on a length of the crank arm and the rotation angle and multiplying the detected pedaling force by the vertical displacement as the work.

In one embodiment of the invention, the calculation apparatus includes multiplying the pedaling force detected within the time period by the vertical displacement as the work, wherein the statistic value includes a mean value and a maximum value.

In one embodiment of the invention, the smart pedal further includes a pedal main structure, a sensor support, and a pedal panel. The pedal main structure is pivotally connected at the end of the crank arm. The sensor support is fixed on the pedal main structure. The pedal panel is disposed on the sensor support. A groove is provided between the pedal panel and the sensor support for limiting the pedal panel to move along the groove in a direction perpendicular to the sensor support when being applied with force. The pressure sensor is disposed between the sensor support and the pedal panel.

In one embodiment of the invention, the smart pedal further includes a casing and a transmission apparatus. The casing is fixed to the pedal main structure. The transmission apparatus is disposed within the casing and coupled to the pressure sensor for transmitting the pedaling force detected by the pressure sensor to the calculation apparatus.

In one embodiment of the invention, the calculation apparatus is disposed within the casing.

In one embodiment of the invention, the smart pedal further includes an inclination sensor disposed at the pedal main structure for detecting an inclined angle of the smart pedal at each time point.

In one embodiment of the invention, the calculation apparatus comprises calculating a displacement of the smart pedal in a direction of the pedaling force by using the inclined angle detected by the inclination sensor and the rotation angle detected by the orientation sensor and calculating the work done by the user on the smart pedal based on the pedaling force detected at each time point and the calculated displacement.

In one embodiment of the invention, the system further includes a torque sensor disposed at the crank arm for detecting a work done by the crank arm on the chainring of the bicycle apparatus. The calculation apparatus detects the work by using the torque sensor within a time period that the pressure sensor detects the pedaling force and calculates a difference between the work calculated based on the pedaling force and the rotation angle of the crank arm and the work detected by the torque sensor to generate an energy loss of the user pedaling the pedal panel.

The smart pedal of the invention is disposed at an end of a crank arm of a bicycle apparatus opposite to a chainring and includes a pedal main structure, a sensor support, a pedal panel, a pressure sensor, a casing, and a transmission apparatus. The pedal main structure is pivotally connected at the end of the crank arm. The sensor support is fixed on the pedal main structure. The pedal panel is disposed on the sensor support and a groove is provided between the pedal panel and the sensor support for limiting the pedal panel to move along the groove in a direction perpendicular to the sensor support when being applied with force. The pressure sensor is disposed between the sensor support and the pedal panel for detecting a pedaling force applied to the pedal panel. The casing is fixed to the pedal main structure. The transmission apparatus is disposed within the casing and coupled to the pressure sensor for transmitting the pedaling force detected by the pressure sensor to the calculation apparatus.

In one embodiment of the invention, the smart pedal further includes an inclination sensor disposed at the pedal main structure for detecting an inclined angle of the smart pedal at each time point within a time period that a user applies force, wherein the transmission apparatus outputs the detected inclined angle to the calculation apparatus.

In light of the above, the method and system for calculating a work done by pedaling and the smart pedal of the invention accurately measure the pedaling force applied by the user to the pedal by disposing the pressure sensor on the pedal. The displacement of the pedal is calculated based on the rotation angle of the crank arm detected by the orientation sensor. Moreover, the pedal is further disposed with the inclination sensor for detecting the inclined angle of the pedal at the time the user pedals and the detected inclined angle is used to calculate the displacement of the pedal in the direction of the pedaling force. The two are multiplied to obtain the work done by the user pedaling the pedal. Accordingly, the work done by the user pedaling the pedal of the bicycle is accurately calculated.

To provide a further understanding of the aforementioned and other features and advantages of the invention, exemplary embodiments, together with the reference drawings, are described in detail below.

### BRIEF DESCRIPTION OF THE DRAWINGS

FIG. 1 A to FIG. 1C are diagrams illustrating relationships between an applied force and a rotation angle of a crank arm in a conventional bicycle pedaled by a user.

FIG. 2 is a schematic diagram illustrating a system for calculating a work done by pedaling according to one embodiment of the invention.

FIG. 3A and FIG. 3B are respectively a schematic diagram and an exploded diagram illustrating a smart pedal according to one embodiment of the invention.

FIG. 4 is a flowchart illustrating a method for calculating a work done by pedaling according to one embodiment of the invention.

FIG. 5 is an example illustrating a method for calculating a work done by pedaling according to one embodiment of the invention.

FIG. 6 is a flowchart illustrating a method for calculating a work done by pedaling according to one embodiment of the invention.

FIG. 7A and FIG. 7B are examples illustrating a method for calculating a work done by pedaling according to one embodiment of the invention.

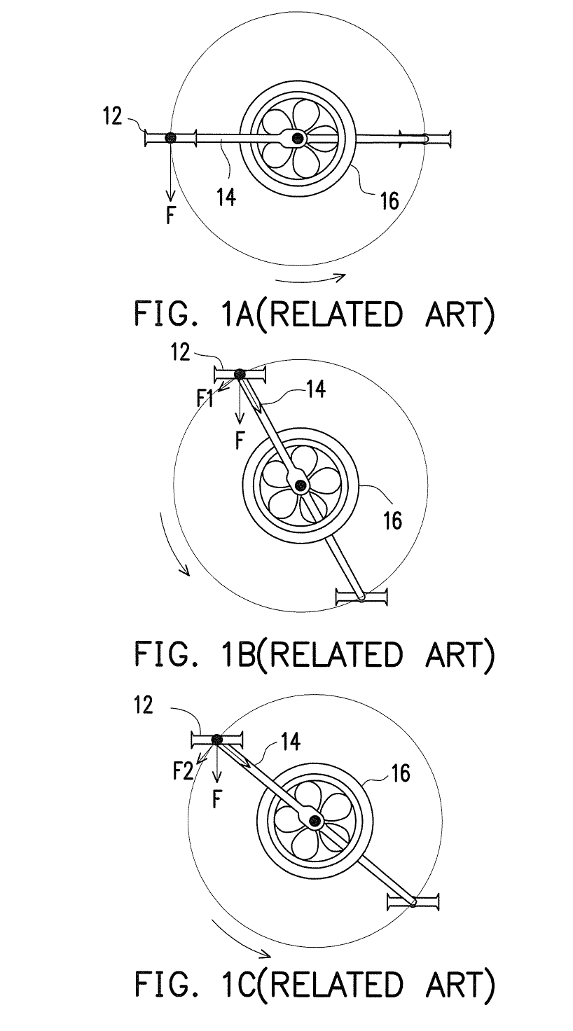

### DESCRIPTION OF THE EMBODIMENTS

A work done on an object refers to a force applied to the object multiplied by a displacement of the object along a direction of the force. In the invention, a pressure sensor is directly installed on the object to which the force is applied (i.e., a pedal) by a user pedaling a bicycle to measure a force that the user actually exerts. Moreover, an orientation sensor is installed on a crank arm to measure a position of the pedal at the time the user exerts the force and a position of the pedal after the pedal is applied with the force. In addition, in the invention, an inclination sensor is further installed on the pedal to detect an angle of the pedal when being pedaled and thereby convert a displacement of the pedal in a pedaling direction. Accordingly, a work done by the user can be accurately calculated by the method of the invention.

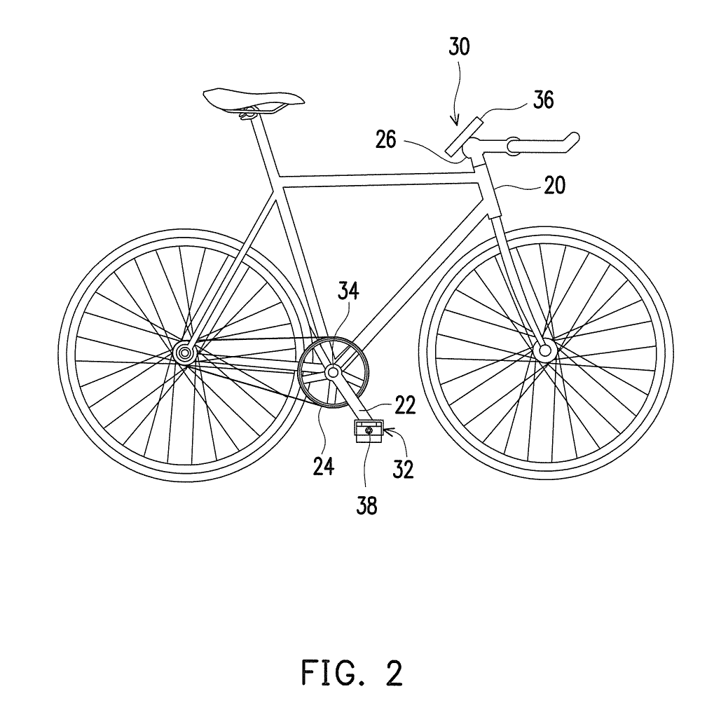

FIG. 2 is a schematic diagram illustrating a system for calculating a work done by pedaling according to one embodiment of the invention. Referring to FIG. 2, a system 30 for calculating a work done by pedaling of the present embodiment is disposed on a bicycle apparatus 20 which includes a smart pedal 32 disposed at an end of a crank arm 22 opposite to a chainring 24, an orientation sensor 34 disposed at the crank arm 22, and a calculation apparatus 36 disposed on a handle 26. Specifically, the smart pedal 32 is used to detect a pedaling force applied by a user to the smart pedal 32 when pedaled by the user. The orientation sensor 34 is used to detect a rotation angle of the crank arm 22 when the user pedals the smart pedal 32. The calculation apparatus 36 is, for example, a mobile phone, a tablet computer, or another electronic device having computational capability that can be installed on a fixation holder on the handle 26 to receive the pedaling force detected by the smart pedal 32 and the rotation angle of the crank arm 22 detected by the orientation sensor 34, correct a displacement of the smart pedal 32 as an effective displacement along a direction of force by using an inclination sensor 38 installed on the smart pedal 32, and thereby calculate a work done by the user pedaling the smart pedal 32. The calculation apparatus 36 includes a display device, for example, for displaying the calculated work for the user's review.

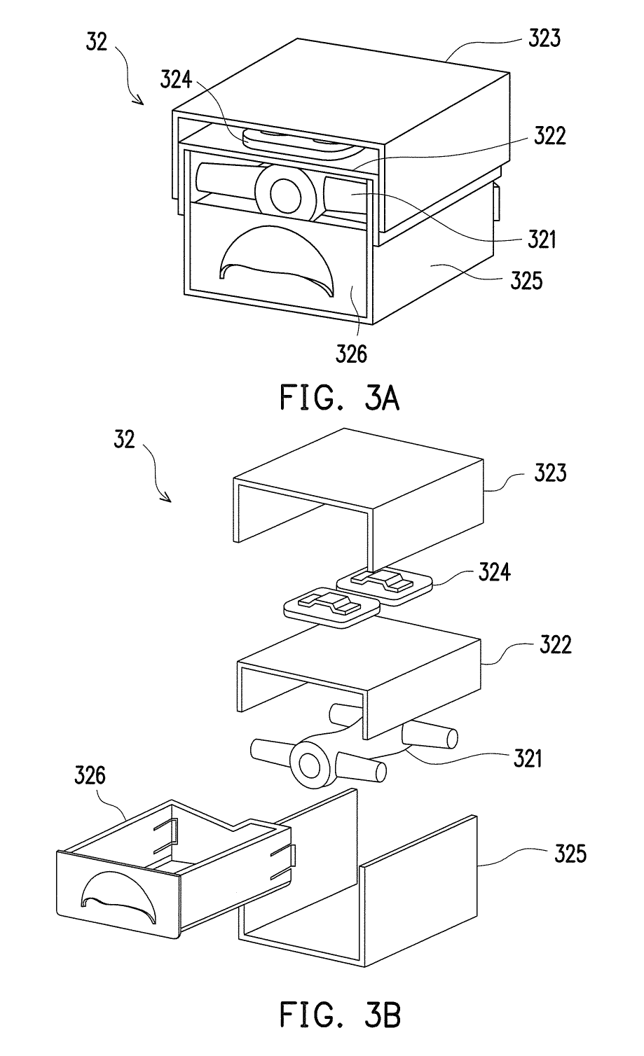

FIG. 3A and FIG. 3B are respectively a schematic diagram and an exploded diagram illustrating a smart pedal according to one embodiment of the invention. Specifically, FIG. 3A illustrates the composition of the smart pedal 32 in FIG. 2, including a pedal main structure 321, a sensor support 322, a pedal panel 323, a pressure sensor 324, a casing 325, and an electronic device container 326. FIG. 3B illustrates a structure of the smart pedal 32. Referring to FIG. 2 and FIG. 3B at the same time, the pedal main structure 321 is pivotally connected at an end of the crank arm 22 of the bicycle apparatus 20. The sensor support 322 is fixed on the pedal main structure 321. The pedal panel 323 is disposed on the sensor support 322. Specifically, a position-limiting structure or element in the form of a groove or another form is provided between the pedal panel 323 and the sensor support 322 for limiting the pedal panel 323 to move along the groove in a direction perpendicular to the sensor support 322 when being applied with force. The pressure sensor 324 is disposed between the sensor support 322 and the pedal panel 323 for detecting a pedaling force applied by the user to the pedal panel 323. Since the groove between the pedal panel 323 and the sensor support 322 limits the pedal panel 323 to move in the vertical direction only, the pressure detected by the pressure sensor 324 is also the pedaling force perpendicular to the pedal panel 323.

On the other hand, the casing 325 is fixed to the pedal main structure 321, and is located below the pedal main structure 321, for example, wherein an accommodating space is provided for accommodating the electronic device container 326. In the electronic device container 326, a transmission apparatus (not illustrated), such as a Bluetooth transmission module, or another sensor may be placed, wherein the transmission apparatus is coupled to the pressure sensor 324 for transmitting the pedaling force detected by the pressure sensor 324 to the calculation apparatus 36 for the calculation apparatus 36 to calculate the work done by the user pedaling the smart pedal 32 accordingly.

It should be noted that although the casing 325 of the present embodiment is designed to be open-sided for receiving the electronic device container 326, in other embodiments, the casing 325 may also be designed to be close-sided to contain the transmission apparatus or another sensor within the casing 325, which shall not be limited here.

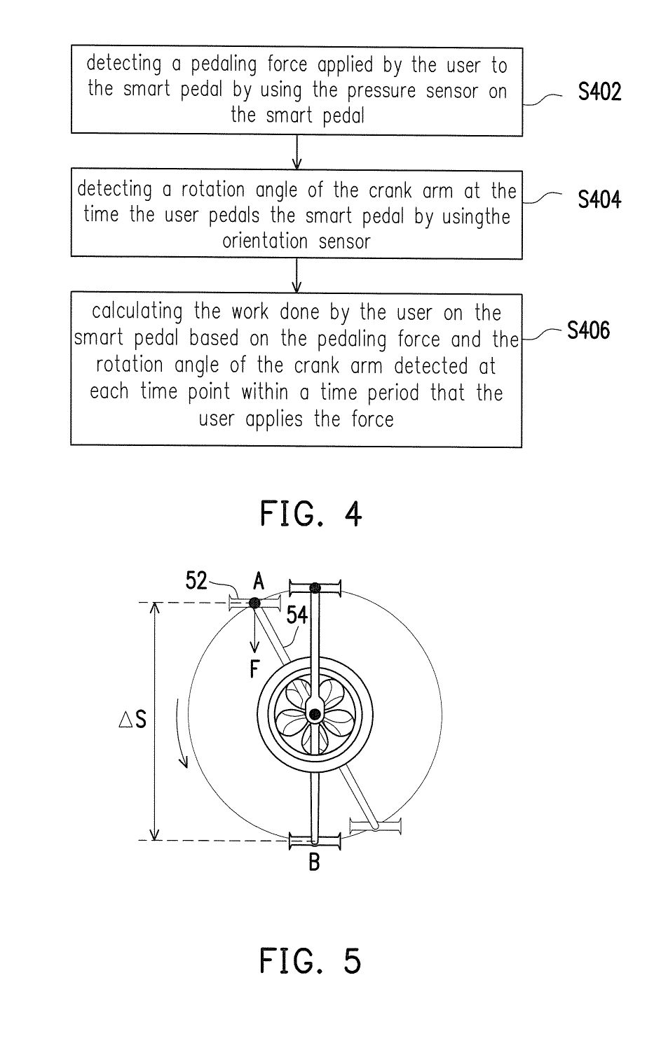

FIG. 4 is a flowchart illustrating a method for calculating a work done by pedaling according to one embodiment of the invention. Referring to FIG. 2, FIG. 3, and FIG. 4 at the same time, the method of the present embodiment is adapted for the above-described system 30 for calculating a work done by pedaling. Detailed procedures of the method of the present embodiment will be described below with reference to each of the components of the system 30 for calculating a work done by pedaling in FIG. 2 and FIG. 3.

First, the pressure sensor 324 on the smart pedal 32 is used to detect a pedaling force applied by the user to the smart pedal 32 (step S402); meanwhile, the orientation sensor 34 is used to detect a rotation angle of the crank arm 22 at the time the user pedals the smart pedal 32 (step S404). The pedaling force detected by the pressure sensor 324 and the rotation angle detected by the orientation sensor 34 are transmitted to the calculation apparatus 36 through wired or wireless transmission methods, for example.

Specifically, the pedaling force detected by the pressure sensor 324 is transmitted to the calculation apparatus 36 via a transmission apparatus, for example. The transmission apparatus is a communication apparatus that is compatible with wireless transmission technologies such as Bluetooth, infrared, Wireless Fidelity (WiFi), or near field communication (NFC) and is capable of transmitting data of the pedaling force to the calculation apparatus 36 through wireless methods. On the other hand, the rotation angle of the crank arm 22 detected by the orientation sensor 34 may also be transmitted to the calculation apparatus 36 via a transmission apparatus similar to the above-described transmission apparatus, for example, or may be transmitted to the smart pedal 32 through a wired method and then be transmitted to the calculation apparatus 36 via the transmission apparatus of the smart pedal 32. In other embodiments, the pedaling force detected by the pressure sensor 324 and the rotation angle detected by the orientation sensor 34 may also be transmitted to the calculation apparatus 36 through other wired or wireless transmission methods, which are not limited to the above-described transmission methods.

Next, the calculation apparatus 36 calculates the work done by the user on the smart pedal 32 based on the pedaling force and the rotation angle of the crank arm 22 detected at each time point within a time period that the user applies the force (step S406). Specifically, in one embedment, the calculation apparatus 36 directly multiplies the pedaling force detected by the smart pedal 32 by the vertical displacement of the smart pedal 32 as the work done by the user, for example.

For example, FIG. 5 is an example illustrating a method for calculating a work done by pedaling according to one embodiment of the invention. Referring to FIG. 5, in the present embodiment, supposing that the force applied by the user is constantly a downward pedaling force F, when a smart pedal 52 detects the pedaling force F, a calculation apparatus (not illustrated) can calculate that the smart pedal 52 is at a position A based on a length of a crank arm 54 and a rotation angle of the crank arm 54 detected at the time point. Then, the smart pedal 52 constantly detects the pedaling force F until the pedaling force F disappears. Based on the rotation angle of the crank arm 54 detected at this time point, it can be calculated that the smart pedal 52 is at a position B. Accordingly, the calculation apparatus can calculate a vertical displacement AS of the smart pedal 52 and multiply it by the pedaling force F to obtain the work done by the user.

It should be noted that in view that a magnitude of the pedaling force may vary in the pedaling process of the user, in another embodiment, the calculation apparatus, for example, calculates a statistic value of the pedaling force detected at each time point within a time period that the smart pedal detects the pedaling force, and multiplies this statistic value by the vertical displacement as the work done by the user, wherein the statistic value is, for example, a mean value or a maximum value, which shall not be limited here.

Moreover, since a direction of the pedaling force may also vary in the pedaling process of the user, in still another embodiment, the calculation apparatus, for example, further detects an inclined angle of the smart pedal in the pedaling process to calculate an effective displacement of the smart pedal in a direction of the pedaling force by using this inclined angle.

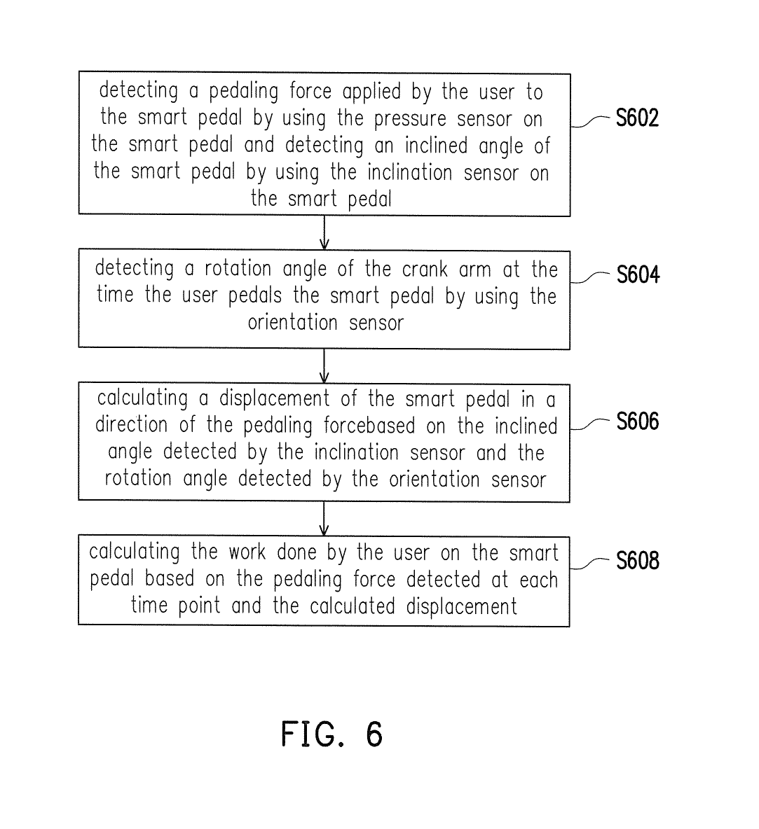

Specifically, FIG. 6 is a flowchart illustrating a method for calculating a work done by pedaling according to one embodiment of the invention. Referring to FIG. 2, FIG. 3, and FIG. 6 at the same time, the method of the present embodiment is adapted for the above-described system 30 for calculating a work done by pedaling. Detailed procedures of the method of the present embodiment will be described below with reference to each of the components of the system 30 for calculating a work done by pedaling in FIG. 2 and FIG. 3.

First, the system 30 for calculating a work done by pedaling detects a pedaling force applied by the user to the smart pedal 32 by using the pressure sensor 324 on the smart pedal 32 and detects an inclined angle of the smart pedal 32 at the time the user applies the force by using the inclination sensor 38 on the smart pedal 32 (step S602). The inclination sensor 38 is disposed at the pedal main structure 321 in the smart pedal 32, for example, for detecting the inclined angle of the smart pedal 32 at each time point. The inclination sensor 38 is a gravity sensor, for example, for measuring an acceleration of the smart pedal 32 on three axes to thereby calculate the inclined angle of the smart pedal 32. The inclination sensor 38 may also be an orientation sensor for detecting a rotation angle of the smart pedal 32 with respect to the crank arm 22 to thereby calculate the inclined angle of the smart pedal 32, which shall not be limited here.

When detecting the pedaling force applied to the smart pedal 32 and the inclined angle of the smart pedal 32 at the time of applying the force, the system 30 for calculating a work done by pedaling also detects a rotation angle of the crank aim 22 at the time the user pedals the smart pedal 32 by using the orientation sensor 34 (step S604). The pedaling force detected by the pressure sensor 324 and the rotation angle detected by the orientation sensor 34 are transmitted to the calculation apparatus 36 through wired or wireless transmission methods, for example. The implementation thereof is identical or similar to the foregoing embodiment of FIG. 4 and thus shall not be repeated here.

Next, based on the inclined angle detected by the inclination sensor 38 and the rotation angle detected by the orientation sensor 34, the calculation apparatus 36 calculates a displacement of the smart pedal 32 in a direction of the pedaling force (step S606), and finally calculates the work done by the user on the smart pedal 32 based on the pedaling force detected at each time point and the calculated displacement (step S608). Specifically, the calculation apparatus 36, for example, calculates a product based on the detected pedaling force and the calculated displacement as the work done by the user on the smart pedal 32, which shall not be limited here.

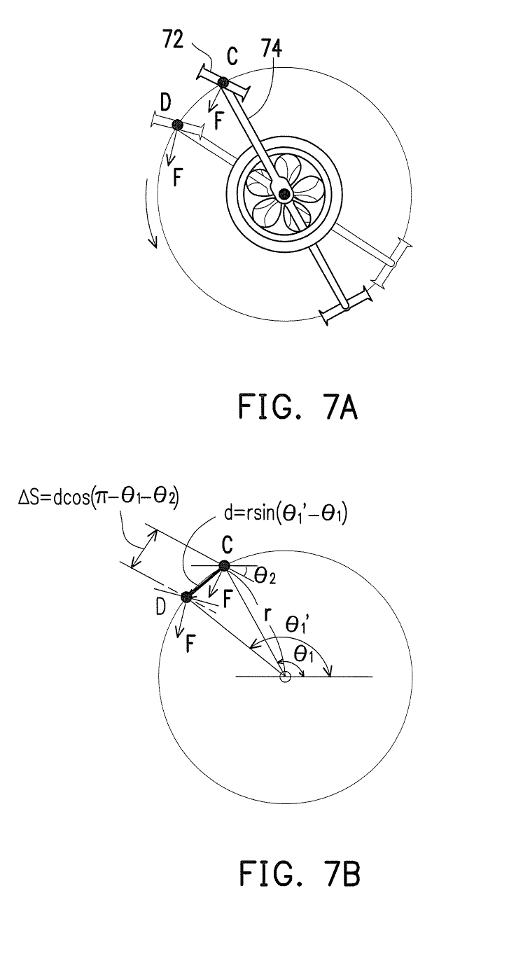

For example, FIG. 7A and FIG. 7B are examples illustrating a method for calculating a work done by pedaling according to one embodiment of the invention. FIG. 7A illustrates that a smart pedal 72 is pedaled by a pedaling force F of the user and is moved from a position C to a position D. FIG. 7B illustrates the relationships among the positions of the smart pedal 72, directions of the pedaling force F, rotation angles of a crank arm 74, and inclined angles of the smart pedal 72 in FIG. 7A. Specifically, when the smart pedal 72 is at the position C, an orientation sensor on the crank arm 74 detects that the rotation angle of the crank arm 74 is a counterclockwise angle θ₁, and an inclination sensor on the smart pedal 72 detects that a rotation angle of the smart pedal 72 is a clockwise angle θ₂. When the smart pedal 72 is at the position D, the orientation sensor on the crank arm 74 detects that the rotation angle of the crank arm 74 is changed to a counterclockwise angle θ₁^{′}. Accordingly, the calculation apparatus can calculate that a displacement of the smart pedal 72 from the position C to the position D is d=r sin(θ₁^{′}−θ₁), wherein r is a length of the crank arm 74. Next, the calculation apparatus can calculate an included angle of a direction of the pedaling force F of the user and a tangent direction of rotation of the crank arm 74 is π−θ₁−θ₂ to further calculate a displacement ΔS=d cos(π−θ₁−θ₂) of the smart pedal 72 from the position C to the position D in the direction of the pedaling force F. Multiplying the pedaling force F by the displacement ΔS=d cos(π−θ₁−θ₂) of the smart pedal 72 in the direction of the pedaling force F, the work done by the user on the smart pedal 72 is obtained as W=F×ΔS=Fr sin(θ₁^{′}−θ₁)cos(π−θ₁−θ₂) . Lastly, after the work W calculated at each time point s accumulated, a total work done by the user pedaling the smart pedal 72 is obtained.

Through the foregoing method, the invention can more accurately calculate the work done by the user pedaling the bicycle pedal, and the work may be further converted into calories for the user to understand the calories consumed when he/she pedals the bicycle pedal.

It should be noted that the system for calculating a work done by pedaling of the invention may further combine with a conventional torque sensor. By comparing the actual work done by the user as calculated by the system of the invention with a work detected by the torque sensor, energy loss of the user pedaling the pedal can be further obtained, and the user may be further assisted in adjusting the posture or angle of pedaling so that the pedaling process can be less energy-consuming or more efficient.

Specifically, within the time period that the smart pedal detects the pedaling force, the calculation apparatus of the system for calculating a work done by pedaling of the invention uses the torque sensor disposed at the pivot of the crank arm and chainring to detect a work done by the crank arm on the chainring of the bicycle apparatus. Thereby, the energy loss of the user pedaling the pedal panel can be obtained by subtracting the work done by the crank arm on the chainring from the work done by the user calculated using the foregoing method. Based on the energy loss, the user may then adjust or correct his/her posture of pedaling and find out the most efficient pedaling manner.

For example, the system for calculating a work done by pedaling may record changes in the force applied and changes in the inclined angle of the pedal in the pedaling process and take into account the position of the pedal at each time point (calculated based on the rotation angle of the crank arm) to construct a model of the user pedaling the pedal for the user's review. The user may accordingly adjust the magnitude and direction of applying force in the pedaling process and learn whether the adjusted pedaling manner is more efficient based on the energy loss data. After repeating a number of times, the most efficient pedaling manner may finally be found out.

In summary of the above, the method and system for calculating a work done by pedaling and the smart pedal of the invention make use of the pedal in the bicycle to detect the pedaling force of the user and simultaneously detect the rotation of the crank arm to obtain the displacement of the pedal. The two are multiplied to obtain the actual work done by the user. Moreover, by detecting the inclined angle of the pedal at the time the user pedals and thereby calculating the displacement of the pedal in the pedaling direction, the work done by the user can be accurately calculated.

Although the invention is disclosed in the embodiments above, the embodiments are not meant to limit the invention. Any person skilled in the art may make slight modifications and variations without departing from the spirit and scope of the invention. Therefore, the protection scope of the invention shall be defined by the claims attached below.

What is claimed is:

1. A method for calculating a work done by pedaling adapted for a calculation apparatus to calculate a work done by a user pedaling a bicycle apparatus, wherein the bicycle apparatus comprises a smart pedal disposed at an end of a crank arm opposite to a chainring and an orientation sensor for detecting a rotation angle of the crank arm, the method comprising:
detecting a pedaling force applied by the user to the smart pedal by using a pressure sensor on the smart pedal;
detecting the rotation angle of the crank arm at the time the user pedals the smart pedal by using the orientation sensor; and
calculating the work done by the user on the smart pedal based on the pedaling force and the rotation angle of the crank arm detected at each time point within a time period that the user applies force.

2. The method according to claim 1, wherein the step of calculating the work done by the user on the smart pedal based on the pedaling force and the rotation angle of the crank arm detected at each time point within the time period that the user applies force comprises:
calculating a vertical displacement of the smart pedal within the time period based on a length of the crank arm and the rotation angle; and
multiplying the detected pedaling force by the vertical displacement to calculate the work.

3. The method according to claim 2, wherein the step of multiplying the detected pedaling force by the vertical displacement to calculate the work comprises:
calculating a statistic value of the pedaling force detected within the time period and multiplying the statistic value by the vertical displacement to calculate the work, wherein the statistic value comprises a mean value and a maximum value.

4. The method according to claim 1, further comprising:
detecting an inclined angle of the smart pedal at said each time point by using an inclination sensor on the smart pedal;
calculating a displacement of the smart pedal in a direction of the pedaling force by using the detected inclined angle and rotation angle; and
calculating the work done by the user on the smart pedal based on the pedaling force detected at said each time point and the calculated displacement.

5. The method according to claim 1, further comprising:
detecting a work done by the crank arm on the chainring of the bicycle apparatus by using a torque sensor within the time period that the pressure sensor detects the pedaling force; and
calculating a difference between the work calculated based on the pedaling force and the rotation angle of the crank arm and the work detected by the torque sensor to generate an energy loss of the user pedaling the smart pedal.

6. A system for calculating a work done by pedaling, comprising:
a smart pedal disposed at an end of a crank arm of a bicycle apparatus opposite to a chainring, comprising a pressure sensor for detecting a pedaling force applied by a user to the smart pedal;
an orientation sensor disposed at the crank arm for detecting a rotation angle of the crank arm at the time the user pedals the smart pedal; and
a calculation apparatus connecting the smart pedal and the orientation sensor for calculating a work done by the user on the smart pedal based on the pedaling force and the rotation angle of the crank arm detected at each time point within a time period that the user applies force.

7. The system according to claim 6, wherein the calculation apparatus comprises calculating a vertical displacement of the smart pedal within the time period based on a length of the crank arm and the rotation angle and multiplying the detected pedaling force by the vertical displacement to calculate the work.

8. The system according to claim 7, wherein the calculation apparatus comprises calculating a statistic value of the pedaling force detected within the time period and multiplying the statistic value by the vertical displacement to calculate the work, wherein the statistic value comprises a mean value and a maximum value.

9. The system according to claim 6, wherein the smart pedal further comprises:
a pedal main structure pivotally connected at the end of the crank arm;
a sensor support fixed on the pedal main structure; and
a pedal panel disposed on the sensor support, wherein a groove is provided between the pedal panel and the sensor support for limiting the pedal panel to move along the groove in a direction perpendicular to the sensor support when being applied with force, wherein the pressure sensor is disposed between the sensor support and the pedal panel.

10. The system according to claim 9, wherein the smart pedal further comprises:
a casing fixed to the pedal main structure; and
a transmission apparatus disposed within the casing and coupled to the pressure sensor for transmitting the pedaling force detected by the pressure sensor to the calculation apparatus.

11. The system according to claim 10, wherein the calculation apparatus is disposed within the casing.

12. The system according to claim 9, wherein the smart pedal further comprises:
an inclination sensor disposed at the pedal main structure for detecting an inclined angle of the smart pedal at said each time point.

13. The system according to claim 12, wherein the calculation apparatus comprises calculating a displacement of the smart pedal in a direction of the pedaling force by using the inclined angle detected by the inclination sensor and the rotation angle detected by the orientation sensor and calculating the work done by the user on the smart pedal based on the pedaling force detected at said each time point and the calculated displacement.

14. The system according to claim 6, further comprising:
a torque sensor disposed at a pivot of the crank arm and the chainring for detecting a work done by the crank arm on the chainring of the bicycle apparatus, wherein
the calculation apparatus detects the work by using the torque sensor within a time period that the pressure sensor detects the pedaling force and calculates a difference between the work calculated based on the pedaling force and the rotation angle of the crank arm and the work detected by the torque sensor to generate an energy loss of the user pedaling the pedal panel.

15. A smart pedal disposed at an end of a crank aim of a bicycle apparatus opposite to a chainring, the smart pedal comprising:
a pedal main structure pivotally connected at the end of the crank arm;
a sensor support fixed on the pedal main structure;
a pedal panel disposed on the sensor support, wherein a groove is provided between the pedal panel and the sensor support for limiting the pedal panel to move along the groove in a direction perpendicular to the sensor support when being applied with force;
a pressure sensor disposed between the sensor support and the pedal panel for detecting a pedaling force applied to the pedal panel;
a casing fixed to the pedal main structure; and
a transmission apparatus disposed within the casing and coupled to the pressure sensor for transmitting the pedaling force detected by the pressure sensor to the calculation apparatus.

16. The smart pedal according to claim 15, further comprising:
an inclination sensor disposed at the pedal main structure for detecting an inclined angle of the smart pedal at each time point within a time period that a user applies force, wherein the transmission apparatus outputs the detected inclined angle to the calculation apparatus.
